(19) United States
(12) Patent Application Publication
(10) Pub. No.: US 2020/0273002 A1
(43) Pub. Date: Aug. 27, 2020

(54) Cryptocurrency Exchange and Value Management Application

(71) Applicant: Paul Regen, Felton, CA (US)

(72) Inventor: Paul Regen, Felton, CA (US)

(21) Appl. No.: 16/240,744

(22) Filed: Jan. 5, 2019

Related U.S. Application Data
(60) Provisional application No. 62/614,249, filed on Jan. 5, 2018.

(51) Int. Cl. G06Q 20/06; H04L 9/06; G06Q 20/36; G06Q 20/20; G06Q 20/32

(52) U.S. Cl. CPC G06Q 20/0658; H04L 9/0637; G06Q 20/3265; G06Q 20/204; G06Q 20/3678

(57) ABSTRACT

Taught is a system for the exchange and value management of cryptocurrencies using servers/VPNs to enhance the knowledge of a user in order to manage/exchange cryptocurrencies, purchase merchandise with cryptocurrencies or invest with cryptocurrencies. These activities are done via smart devices or IOT (internet of things) devices with the ability to see a screen and manipulate data to best serve ones needs in the management of and purchasing with cryptocurrencies or exchanged cryptocurrencies.

### CROSS-REFERENCE TO RELATED APPLICATIONS

The present application claims priority as a continuation to U.S. provisional patent application Ser. No. 62/614,249, filed on Jan. 5, 2018The entire disclosure of application, Ser. No. 62/614,249 is included herein in its entirety at least by reference.

### BACKGROUND OF THE INVENTION

### 1. Field of the Invention

The present invention is in the field of digital currency, more particularly known as crypotcurrency and the management thereof

### 2. Discussion of the State of the Art

The exchange of value of currencies in the world today is going through an evolutionary change where digitally encrypted money may soon replace centralized fiat money. An example of this was the introduction of Bitcoin in January 2009. In less than 10 years, i.e., as of Nov. 6, 2017, there were over 1,100 cryptocurrencies being offered and the list is still growing. As this shift from a centralized wealth management environment to a decentralized wealth management environment continues it is creating a demand for management tools that address the upcoming challenges

### SUMMARY OF THE INVENTION

In summery we have a system for cryptocurrency exchange and value management comprising a plurality of smart devices equipped with a smart application installed on smartphones or devices optimized to make cryptocurrency transactions with hard wired or wireless encrypted connections to the internet.

In one embodiment a connection to a secure server or virtual private network (VPN) is made which enables secure connection to a cryptocurrency data analytics and exchange facility capable of tracking the value of all cryptocurrencies available and capable of exchanging one cryptocurrency for another cryptocurrency among other analytics capabilities through the applications resident on the smart devices.

In one embodiment a transaction capability for purchase of goods and or services with access to a payment terminal for purchasing goods and or services with cryptocurrencies is provided.

In one embodiment a transaction capability for purchase the of investments paid in cryptocurrency or fiat currency is provided along with access to a blockchain exchange network wherein a users transaction may be recorded and memorialized according to blockchain protocols.

In another embodiment a user uses an IOT device such as a smartphone to initiate a purchase of merchandise by utilizing the smartphones onboard application wherein the smartphone, through the application connects to a cryptocurrency data analytics facility capable of tracking the value of all cryptocurrencies owned by a user including cryptocurrencies not owned by a user but that may be exchanged to another cryptocurrency preferred by a merchant payment terminal for payment of goods and or services wherein the preferred cryptocurrency is chosen by the user for a purchase and that currency is accepted by the merchant payment terminal and a transaction is consummated and recorded in the blockchain network.

In another embodiment the cryptocurrencies owned by a user including cryptocurrencies not owned by a user but that may be exchanged to another cryptocurrency preferred by a merchant payment terminal for payment of goods and or services wherein the preferred cryptocurrency is chosen by the user for a purchase and that currency is not accepted by the merchant payment terminal wherein the cryptocurrency data analytics and exchange facility finds several cryptocurrencies suitable to the merchant and the user selects the one of several he chooses displayed on his smartphone. His smartphone initiates a sale of the users owned chosen cryptocurrency and buys the cryptocurrency that the merchant will accept behind the scenes to make a seamless transaction. A transaction is consummated with the merchant payment terminal and recorded in the blockchain network. Then the application resident on the phone and the connection to the analytics module record the transaction as well.

In another embodiment setup preferences are displayed on a users smartphone while configuring a smart application of the invention comprising at least one or more of:

a preference menu, users intended uses, investments choices, product purchases, selecting risk levels such as high risk, Medium risk or Low risk, enabling cryptocurrency data analytics, enabling investment prioritizing algorithms, enabling auto alerts, enabling auto currency conversions, enabling auto currency management, enabling algorithms including expense tracking , investment gains, potentially taxable events like purchases or investment income gains and losses as well as currency Data Analytics, investment prioritizing algorithms based on user preferences, and configuring the form of a receipt when any of their transactions have been recorded in the blockchain network.

The exchange of value of currencies in the world today is going through an evolutionary change where digitally encrypted money may soon replace centralized fiat money. An example of this was the introduction of Bitcoin in January 2009. In less than 10 years, i.e., as of Nov. 6, 2017, there were over 1,100 cryptocurrencies being offered and the list is still growing. As this shift from a centralized wealth management environment to a decentralized wealth management environment continues it is creating a demand for management tools that address the upcoming challenges

### BRIEF DESCRIPTION OF THE DRAWING FIGURES

FIG. 1 outlines a flow diagram of how the invention will perform its specified functions.

FIG. 2 describes the type of preferences that will be used to help the user more effectively use the crypotcurrency management software with a smart device.

FIG. 3 describes the functions that may be built into the product.

FIG. 4 shows how the invention may be used to interact with merchants in performing a purchase using a smartphone or smart card.

FIG. 5 shows how the product may be used as an investment tool for leveraging cryptocurrencies using a formula to weigh key parameters of various currencies then grading them in accordance with these parameters. The output is a list of choices Y₁ through Y_{N} identifying high-risk or low-risk investments based on the users selected preferences.

FIG. 6 shows a data table of the weighted parameters used in the formula shown in FIG. 5.

### DETAILED DESCRIPTION

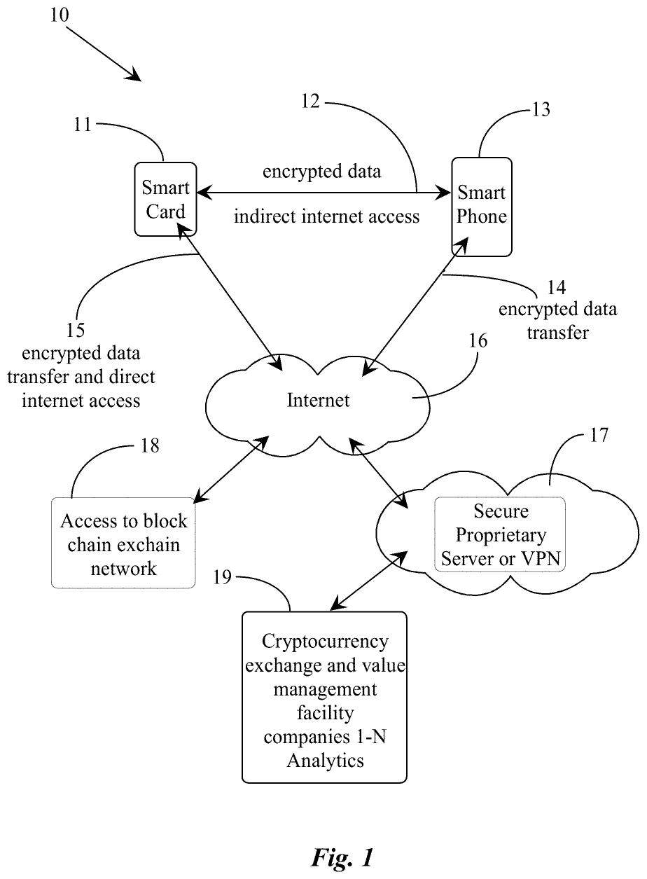

FIG. 1 outlines a flow diagram of how the invention will perform its specified functions. Referring now to the invention in more detail, in FIG. 1 the overview is shown as element 10. In the figure are a smart card 11 and a smartphone 13 i.e., smart IOT devices and Internet 16. Reference points 12, 14 & 15 show how the smart devices are wirelessly linked to each other and the Internet so they can interact with the blockchain exchange network 18.

Note the data being wirelessly transmitted between the devices and the Internet are implementing encrypted data algorithms to insure privacy between devices as well as over the Internet as we can see in reference to elements 12, 14 15 and 16 of FIG. 1.

Element 17 presents a secure server or Virtual Private Network (VPN) used to gather (1-N) cryptocurrency companies element 19 and provide data analytics prior to sending the data to the smart devices that are participating in the linked network.

The smart devices 11 & 13 will provide further data processing and analysis based on user preference. Following the data analysis in one embodiment a list of cryptocurrency available for purchase will be presented for the user to choose as an investment vehicle. In another embodiment the user will be presented with a choice of cryptocurrencies to use when making a purchase, also based on previously set preferences. The purchases may be peer-to-peer or online purchases. The smart card 23 and smartphone 24 will also be able to calculate trading rates in the event the cryptocurrency has to be converted from one cryptocurrency to another currency including fiat currency.

Once the transactions have been entered into the block-chain network 18 a confirmation is sent to the smart device 11 or 13 presenting the user with a confirmation or status update.

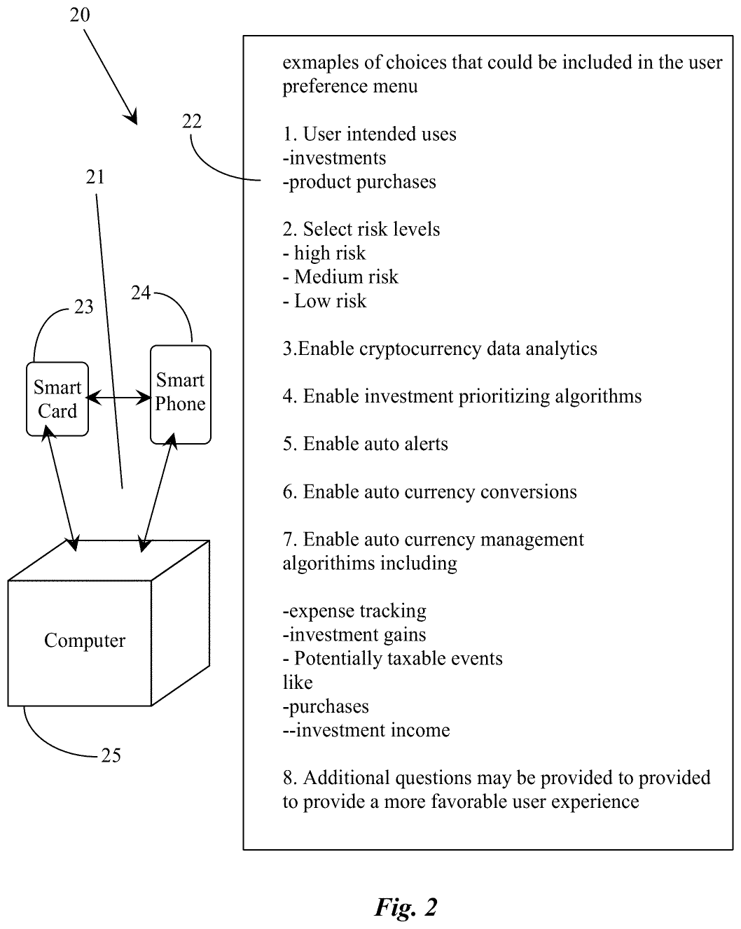

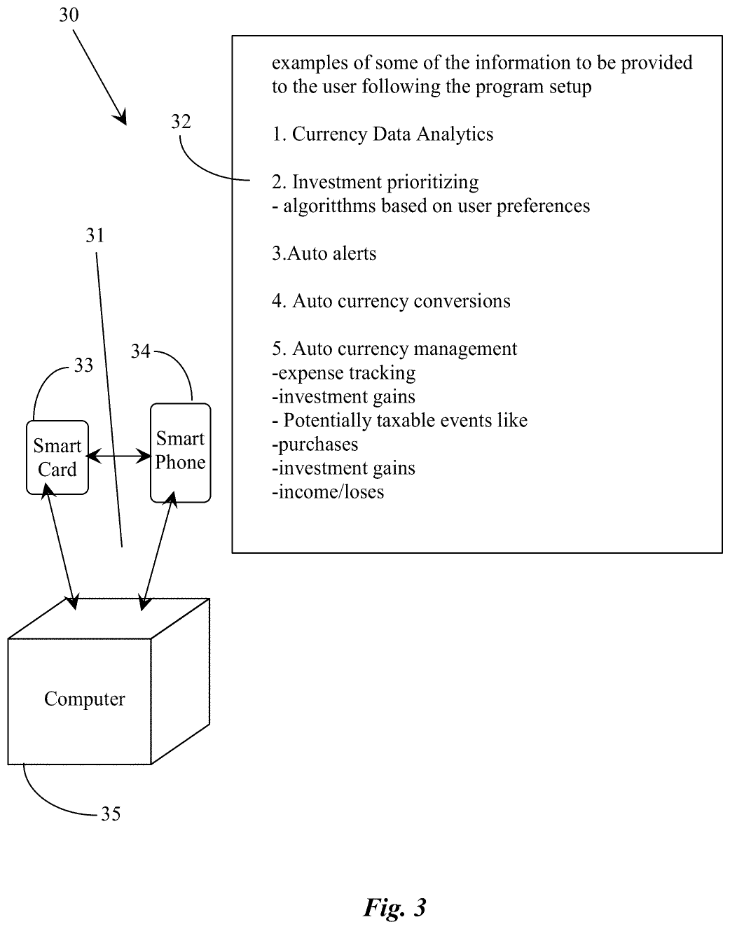

Referring now to FIG. 2 and FIG. 3 shows the elements 20 & 30 involved in performing the management and prioritizing functions. In one embodiment the invention is designed to work with a group of smart devices i.e., smart card 23, 33 smartphone 24, 34 and a computer 25, 35. Each element within the network 21, 31 in one embodiment is programmed to work independently and only provide data backup to insure system integrity. In another embodiment the smart card 23, 33 is designed and programmed to be dependent on the smartphone 24, 34 and/or a computer 25, 35 to be in communication with the Internet for data transmission and data reception for keeping the internal data and software up to date. In setting up the application program, the user of the smart card 23, smartphone 24, computer, 25 will be directed to a preference menu to perform an initial setup of the program 22. Note, only one device within the wirelessly interconnected network requires the initial data entry. Once the data is entered, it can be shared among devices within the smart device network 21, 31. Following the initial user setup procedure 22 the program running on the smart devices network 21, 31 can start performing and delivering the users preferred data of interest 32. The user may then decide to act on the data such as purchase more cryptocurrencies, sell what they have or exchange one cryptocurrency for another through the use of their smart cards 23, 33 or their smartphones 24, 34.

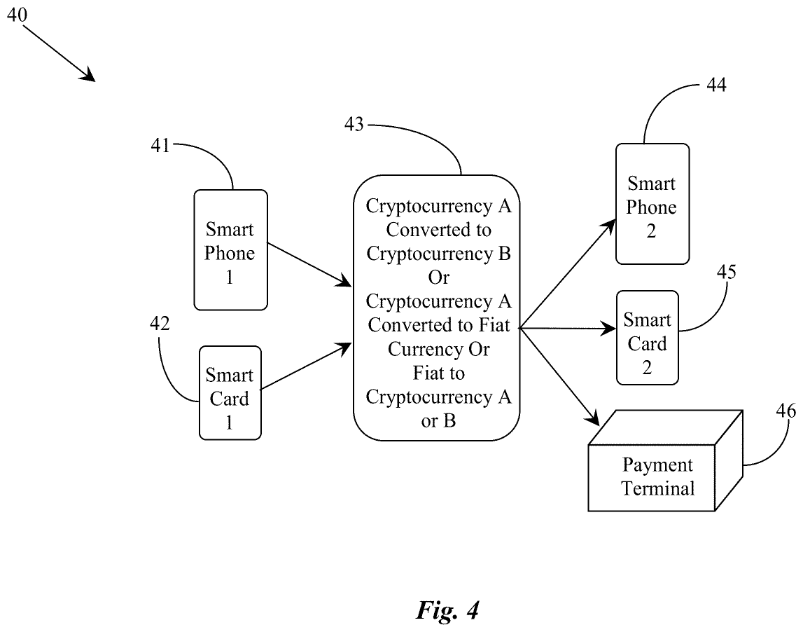

In FIG. 4 element 40 shows how the invention may be used peer-to-peer to interface with merchants in performing a purchase using various currencies on a smartphone 41, 44, smart card 42, 45, or a terminal 46 to make a product purchase. It also shows how the invention may be used to make a purchase using a cryptocurrency converting algorithm from current data provided by the Secure Proprietary Server 17 in one embodiment or Virtual Private Network (VPN) 17 in another embodiment to provide the necessary real-time data to calculate the proper conversions making it possible to perform the conversions of one currency to another currency 43.

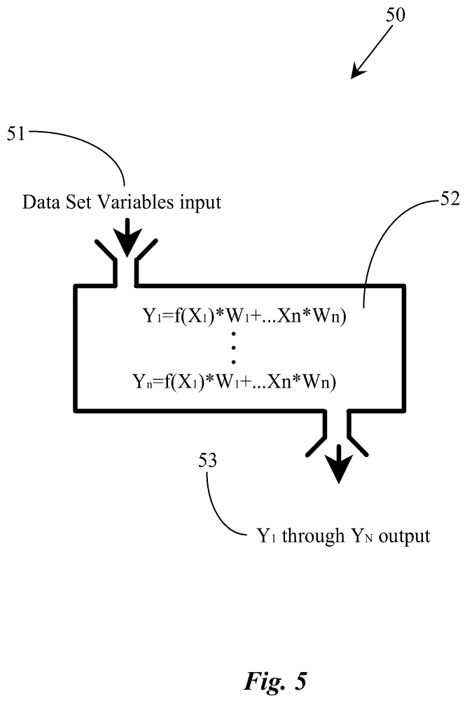

FIG. 5 shows how the product may be used as an investment tool for leveraging cryptocurrencies using a formula 50 to weigh key parameters of various currencies then grading them in accordance with these parameters 51. The output 53 is a list of choices Y1 through YN identifying high-risk or low-risk investments based on the users selected preferences.

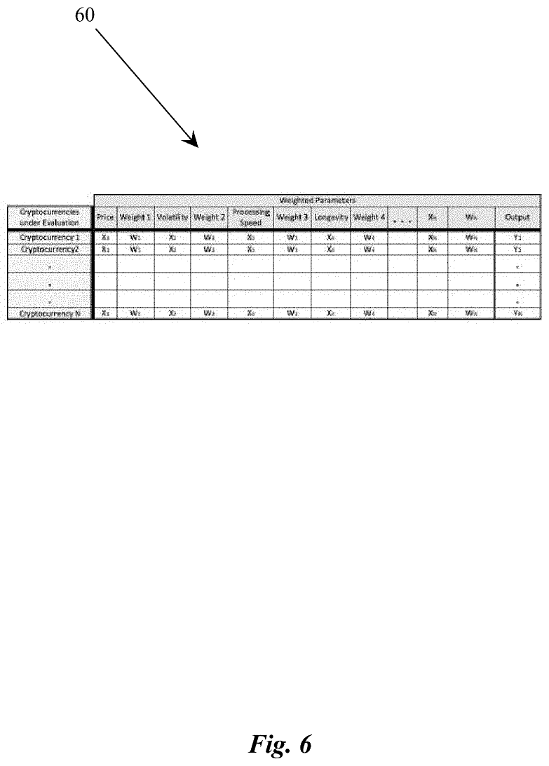

FIG. 5 & FIG. 6 shows the elements 51 how the product may be used as an investment tool for leveraging cryptocurrencies 52. The data input 51 is a set of variables obtained from the Secure Proprietary Server 17 of FIG. 1 in one embodiment or a VPN in another embodiment. VPN with server 17 then processed on the users smart card 33, smartphone 34 or computer 35, i.e., the smart devices.

The smart devices then perform the calculation according to the data delivered by the servers weighing the importance of the data in accordance with the user's preferences. The output Y₁ through Y_{N} is then presented to the user as choices to sell or purchase more cryptocurrency.

FIG. 6 presents a table showing the type of data that could be used and how it can be weighed in a prioritizing process. FIG. 6 shows a table of the weighted parameters used in the formula shown in FIG. 5.

Referring to FIG. 6, Note, X1-XN are the variables provided by the Secure Proprietary Server 17 in one embodiment or Virtual Private Network (VPN) 17 in another embodiment. The data W1-WN is the data derived from the user's preferences. Y1-YN are the result and represents cryptocurrency company 1-cryptocurrency company 2.

FIG. 6 shows a data table of the weighted parameters used in the formula shown in FIG. 5.

What is claimed is:

1. A system for cryptocurrency exchange and value management comprising:
a plurality of smart devices equipped with an application optimized to make cryptocurrency transactions with hard wired or wireless encrypted connections to the internet;
connection to a secure server or virtual private network (VPN);
connection to a cryptocurrency data analytics and exchange facility capable of tracking the value of all cryptocurrencies available and capable of exchanging one cryptocurrency for another cryptocurrency among other analytics capabilities;
a transaction capability for purchase of goods and or services;
access to a payment terminal for purchasing goods and or services with cryptocurrencies;
a transaction capability for purchase of investments paid in cryptocurrency or fiat currency;
access to a blockchain exchange network wherein a user's transaction may be recorded and memorialized according to blockchain protocols.

2. The system of claim 1 wherein a user uses an TOT device such as a smartphone to initiate a purchase of merchandise by utilizing the smartphones onboard application wherein the smartphone, through the application connects to a cryptocurrency data analytics facility capable of tracking the value of all cryptocurrencies owned by a user including cryptocurrencies not owned by a user but that may be exchanged to another cryptocurrency preferred by a merchant payment terminal for payment of goods and or services wherein the preferred cryptocurrency is chosen by the user for a purchase and that currency is accepted by the merchant payment terminal and a transaction is consummated and recorded in the blockchain network.

3. The system of claim 2 wherein the cryptocurrencies owned by a user including cryptocurrencies not owned by a user but that may be exchanged to another cryptocurrency preferred by a merchant payment terminal for payment of goods and or services wherein the preferred cryptocurrency is chosen by the user for a purchase and that currency is not accepted by the merchant payment terminal wherein the cryptocurrency data analytics and exchange facility finds several cryptocurrencies suitable to the merchant and the user selects the one of several he chooses displayed on his smartphone to make a transaction a transaction is consummated with the merchant payment terminal and recorded in the blockchain network.

4. The system of claim 1 wherein setup preferences are displayed on smartphone comprising at least one or more of:
a preference menu;
users intended uses;
investments choices;
product purchases;
selecting risk levels such as high risk, Medium risk or Low risk;
enabling cryptocurrency data analytics;
enabling investment prioritizing algorithms;
enabling auto alerts;
enabling auto currency conversions;
enabling auto currency management;
enabling algorithms including expense tracking, investment gains, potentially taxable events like purchases or investment income gains and losses;
currency Data Analytics;
investment prioritizing;
algorithms based on user preferences; and the form of a receipt when any of their transactions have been recorded in the blockchain network.
